(19) United States
(12) Patent Application Publication
(10) Pub. No.: US 2026/0113744 A1
(43) Pub. Date: Apr. 23, 2026

(54) METHOD FOR WIRELESS COMMUNICATIONS, TERMINAL DEVICE, AND NETWORK DEVICE

(71) Applicant: Quectel Wireless Solutions Co., Ltd., Shanghai (CN)

(72) Inventors: Qufang HUANG, Shanghai (CN); Jin LIU, Shanghai (CN); Ling LYU, Shanghai (CN)

(73) Assignee: Quectel Wireless Solutions Co., Ltd., Shanghai (CN)

(21) Appl. No.: 19/422,347

(22) Filed: Dec. 16, 2025

Related U.S. Application Data
(63) Continuation of application No. PCT/CN2024/113936, filed on Aug. 22, 2024.

(51) Int. Cl. H04W 72/1268; H04W 56/00; H04W 64/00

(52) U.S. Cl. CPC H04W 72/1268; H04W 56/0045; H04W 64/006

(57) ABSTRACT

A method for wireless communications includes: determining, by a terminal device based on relative motion information between a network device and the terminal device, a collision ambiguity period for uplink transmission, where the collision ambiguity period is configured as a period of cancelling the uplink transmission. Alternatively, the method includes: determining, by a network device based on relative motion information between the network device and a terminal device, a collision ambiguity period for downlink reception, where the collision ambiguity period is configured as a period of cancelling the downlink reception. The collision ambiguity period for uplink transmission is determined based on the relative motion information between the network device and the terminal device, thereby preventing substantial resource wastage while avoiding collisions between uplink transmission and downlink reception.

### CROSS-REFERENCE TO RELATED APPLICATIONS

This application is a continuation of International Application No. PCT/CN2024/113936, filed on Aug. 22, 2024, the content of which is incorporated herein by reference in its entirety.

### TECHNICAL FIELD

The present disclosure relates to the technical field of communications, and more particularly, to a method for wireless communications, a terminal device, and a network device.

### BACKGROUND

Non-terrestrial networks (NTN) refer to networks that provide communication services through non-terrestrial platforms, such as satellites and unmanned aerial vehicles. Due to the rapid movement of satellites relative to the ground, an uplink transmission and a downlink reception between a network device and a terminal device located at a relatively long distance from the network device may experience resource collisions and conflicts as a result of a mismatch (also referred to as a discrepancy) in time advance (TA), thereby affecting communication performance.

### SUMMARY

The present disclosure provides a method for wireless communications, a terminal device, and a network device. Various aspects of the present disclosure are described below.

In a first aspect, a method for wireless communications is provided. The method includes: determining, by a terminal device based on relative motion information between a network device and the terminal device, a collision ambiguity period for uplink transmission, where the collision ambiguity period is configured as a period of cancelling the uplink transmission.

In a second aspect, a method for wireless communications is provided. The method includes: determining, by a network device based on relative motion information between the network device and a terminal device, a collision ambiguity period for downlink reception, where the collision ambiguity period is configured as a period of cancelling the downlink reception.

In a third aspect, a terminal device is provided. The terminal device includes a processing unit configured to determine, based on relative motion information between a network device and the terminal device, a collision ambiguity period for uplink transmission, where the collision ambiguity period is configured as a period of cancelling the uplink transmission.

In a fourth aspect, a network device is provided. The network device includes a processing unit configured to determine, based on relative motion information between the network device and a terminal device, a collision ambiguity period for downlink reception, where the collision ambiguity period is configured as a period of cancelling the downlink reception.

In a fifth aspect, a terminal device is provided. The terminal device includes: a transceiver; a memory configured to store one or more programs; and a processor configured to execute the programs stored in the memory and to control the transceiver to receive or transmit signals, to cause the terminal device to perform the method according to the first aspect.

In a sixth aspect, a network device is provided. The network device includes: a transceiver; a memory configured to store one or more programs; and a processor configured to execute the programs stored in the memory and to control the transceiver to receive or transmit signals, to cause the network device to perform the method according to the second aspect.

In a seventh aspect, a device is provided, which includes a processor configured to execute a program stored in a memory, to cause the device to perform the method according to the first aspect or the second aspect.

In an eight aspect, a chip is provided, which includes a processor configured to execute a program stored in a memory, to cause a device having the chip is installed to perform the method according to the first aspect or the second aspect.

In a ninth aspect, a computer-readable storage medium having stored thereon a program is provided, where the program causes the computer to perform the method according to the first aspect or the second aspect.

In a tenth aspect, a computer program product is provided, which includes a program, where the program causes the computer to perform the method according to the first aspect or the second aspect.

In an eleventh aspect, a computer program is provided, which causes the computer to perform the method according to the first aspect or the second aspect.

The present disclosure introduces relative motion information between a network device and a terminal device to determine a collision ambiguity period for uplink transmission, thereby preventing substantial resource wastage while avoiding collisions between uplink transmission and downlink reception.

### BRIEF DESCRIPTION OF THE DRAWINGS

FIG. 1 is a schematic diagram illustrating a system architecture of a wireless communications system applicable to embodiments of the present disclosure.

FIG. 2 is a schematic diagram illustrating a collision between uplink transmission and downlink reception.

FIG. 3 is a flowchart illustrating a method for wireless communications according to an embodiment of the present disclosure.

FIG. 4 is a flowchart illustrating a method for wireless communications according to another embodiment of the present disclosure.

FIG. 5 is a flowchart illustrating a process in which a terminal device and a network device respectively determine a collision ambiguity period for uplink transmission and downlink reception.

FIG. 6 is a schematic diagram illustrating a possible specific implementation of the method shown in FIG. 3.

FIG. 7 is a schematic diagram illustrating a collision between uplink transmission and downlink reception in the method shown in FIG. 6.

FIG. 8 is a schematic diagram illustrating a collision ambiguity period set for an uplink transmission interval when the network device and the terminal device move toward each other.

FIG. 9 is a schematic diagram illustrating a collision ambiguity period set for an uplink transmission interval when the network device and the terminal device move away from each other.

FIG. 10 is a schematic diagram illustrating a possible specific implementation of the method shown in FIG. 4.

FIG. 11 is a schematic diagram illustrating a collision between uplink transmission and downlink reception in the method shown in FIG. 10.

FIG. 12 is a schematic diagram illustrating a collision ambiguity period set for a downlink reception interval when the network device and the terminal device move toward each other.

FIG. 13 is a schematic diagram illustrating a collision ambiguity period set for a downlink reception interval when the network device and the terminal device move away from each other.

FIG. 14 is a schematic structural diagram illustrating a terminal device according to an embodiment of the present disclosure.

FIG. 15 is a schematic structural diagram illustrating a network device according to an embodiment of the present disclosure.

FIG. 16 is a schematic diagram illustrating a communications device according to an embodiment of the present disclosure.

### DETAILED DESCRIPTION OF THE EMBODIMENTS

The technical solutions of the present disclosure will be described below with reference to the drawings.

### Wireless Communications System

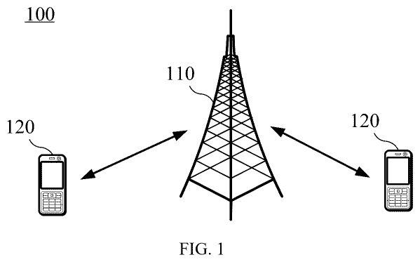

FIG. 1 is a schematic diagram illustrating an exemplary system architecture of a wireless communications system 100 applicable to embodiments of the present disclosure. The wireless communications system 100 may include a network device 110 and a terminal device 120. The network device 110 may be a device configured to communicate with the terminal device 120. The network device 110 may provide network coverage for a specific geographic area and may communicate with the terminal device 120 located within the coverage area. The terminal device 120 may access a network, such as a wireless network, via the network device 110. Typically, the network device 110 undertakes responsibilities for managing wireless resources and communicating with the terminal device 120. Optionally, the wireless communications system 100 may further include other network entities such as a network controller or a mobility management entity. The embodiments of the present disclosure are not limited in this respect.

It should be understood that the technical solutions of the embodiments of the present disclosure may be applicable to various communications systems, such as a fifth generation (5G) system, a new radio (NR) system, a long term evolution (LTE) system, an LTE frequency division duplex (FDD) system, an LTE time division duplex (TDD) system, and the like. The technical solutions in the present disclosure may also be applicable to future communications systems, such as a sixth generation (6G) mobile communications system, a satellite communications system, and the like.

The terminal device in the embodiments of the present disclosure may also be referred to as user equipment (UE), an access terminal, a user unit, a subscriber station, a mobile station (MS), a mobile terminal (MT), a remote station, a remote terminal, a mobile device, a user terminal, a terminal, a wireless communications device, a user agent, or user apparatus. The terminal device in the embodiments of the present disclosure may refer to a device that provides voice and/or data connectivity to a user, and may be used to connect people, objects, and machines, such as handheld devices or in-vehicle devices having wireless connectivity functions. The terminal device in the embodiments of the present disclosure may be, for example, a mobile phone, a tablet computer (Pad), a notebook computer, a personal digital assistant (PDA), a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and the like. Optionally, the terminal device may be configured to serve as a base station. For example, the terminal device may act as a scheduling entity that provides sidelink signals between terminal devices in vehicle-to-everything (V2X) or device-to-device (D2D) communications. For instance, a cellular phone and a vehicle may communicate with each other using sidelink signals. A cellular phone and a smart home device may communicate with each other without relaying communication signals by a base station.

The network device in the embodiments of the present disclosure may be a device configured to communicate with a terminal device. For example, the network device may be an access network device or a radio access network device. For instance, the network device may be a base station. The term “base station” may broadly cover, or be replaced with, various names such as NodeB, evolved NodeB (eNB), next generation NodeB (gNB), relay station, access point, transmitting and receiving point (TRP), transmitting point (TP), home base station, network controller, access node, radio node, access point (AP), transmission node, transceiver node, base band unit (BBU), remote radio unit (RRU), active antenna unit (AAU), remote radio head (RRH), central unit (CU), distributed unit (DU), and positioning node. The base station may be a macro base station, a micro base station, a relay node, a donor node, or the like, or a combination thereof.

In some deployments, the network device in the embodiments of the present disclosure may be a CU or a DU. Alternatively, the network device may include both a CU and a DU. The gNB may further include an AAU.

The network device and the terminal device may be deployed on land, including indoors or outdoors, handheld or in-vehicle; may be deployed on the water surface; or may be deployed in the air, such as on an aircraft, a balloon, or a satellite. The scenarios in which the network device and the terminal device are deployed are not limited in this respect in the embodiments of the present disclosure.

It should be understood that all or part of the functions of the communications device in the present disclosure may also be implemented by software functions executable on hardware, or by virtualized functions instantiated on a platform (e.g., a cloud platform).

### NTN

An NTN may provide communications services to users in a non-terrestrial manner. That is, communications may be performed between a terminal device and a non-terrestrial network device, such as a satellite (SAT) or an unmanned aircraft system (UAS) platform. An NTN performs data transmission via a space-based or air-based platform, therefore has unique advantages.

For example, in the case of terrestrial network communications, communications devices cannot be deployed in scenarios such as oceans, high mountains, and deserts. In addition, in view of the deployment and operation costs of communications device, terrestrial communications generally do not cover sparsely populated areas. Compared with terrestrial network communications, NTN communications are not subject to geographic limitations. In theory, satellites may orbit the Earth, and thus every corner of the Earth may be covered by satellite communications. Moreover, the area that can be covered by non-terrestrial network device is much larger than that covered by terrestrial communications device, that is, an NTN cell may cover a larger area.

However, due to factors such as rapid movement relative to the ground, orbital altitude, signal interference, and capacity and energy consumption limitations, an NTN network often faces higher latency and more severe Doppler shift effects, which in turn bring more challenges to the NTN network.

### HD-FDD RedCap UEs

A Reduced Capability (RedCap) user equipment operating in a Half-Duplex Frequency Division Duplex (HD-FDD) mode is a special type of user equipment in an NR network. On one hand, the user equipment performs communication using a half-duplex mode and a frequency division multiplexing mode (HD-FDD mode). In the HD-FDD mode, the user equipment is allowed to transmit and receive signals on different frequencies at different times. However, the user equipment cannot receive downlink data while transmitting uplink data, and cannot transmit uplink data while receiving downlink data. On the other hand, a RedCap UE, i.e., a reduced capability user equipment, is a low-complexity type of user equipment formed by trimming down the functions of a user equipment in an NR system. A RedCap UE is also referred to as a lightweight user equipment. The purpose of capability reduction is to meet the specific requirements of mid-end Internet of Things application scenarios, such as industrial wireless sensors, video surveillance, and wearable devices, by reducing air-interface capabilities of the user equipment so as to lower complexity, cost, and power consumption.

### TA

TA is generally used for uplink transmission by a terminal device. In order to make the uplink data of the terminal device arrive at a network device at an expected time, a radio transmission delay caused by distance is estimated, and the uplink data is transmitted in advance by a corresponding amount of time. From the perspective of the terminal device, the TA is essentially a negative offset between a start time of received downlink data and a time of transmitting uplink data. By appropriately controlling the offset of each terminal device, the network device may control the time at which uplink data from different terminal devices arrives at the network device. For a terminal device located farther away from the network device, due to a larger transmission delay, the uplink data needs to be transmitted earlier than that of a terminal device located closer to the network device.

### Collision Conflict

A collision conflict refers to an issue proposed for further study regarding HD-FDD RedCap UEs at the 3GPP RAN #116 meeting. Two types of collision conflict scenarios described as case 3 and case 4 are mainly caused by TA mismatches in NTN scenarios. Specifically, case 3 refers to a collision conflict between semi-statically configured downlink reception and semi-statically configured uplink transmission, while case 4 refers to a collision conflict between dynamically scheduled downlink reception and dynamically scheduled uplink transmission.

As described above, uplink (UL) transmission and downlink (DL) transmission between a terminal device and a network device may experience collision conflicts due to TA mismatches. To address this, the embodiments of the present disclosure propose reducing the probability of collision conflicts between uplink transmission and downlink reception caused by TA mismatches by setting a collision ambiguity period (also referred to as a collision ambiguity interval). Hereinafter, a collision conflict may also be simply referred to as a collision or conflict.

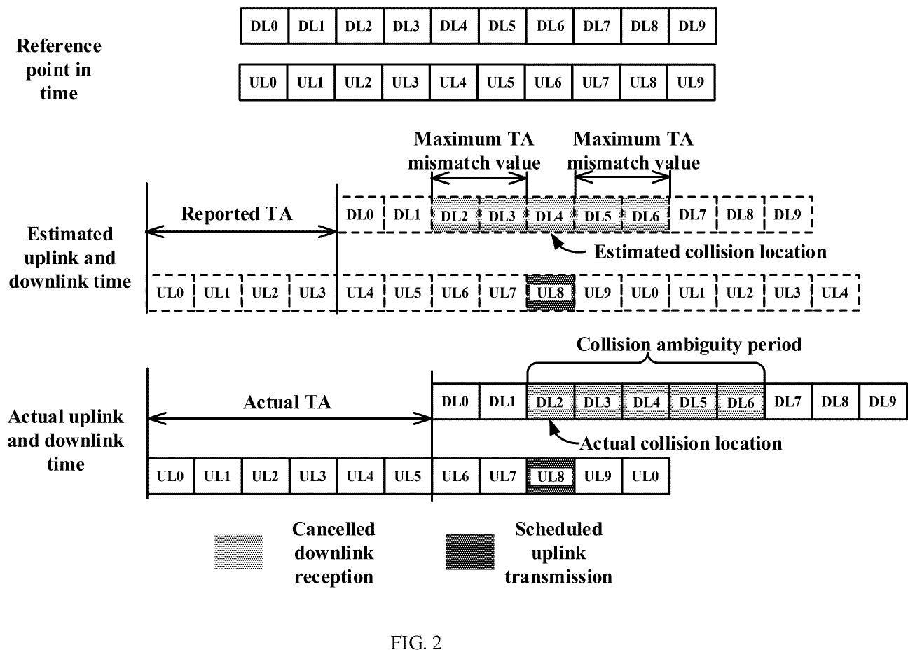

In an example, as shown in FIG. 2, a terminal device may report a TA report to a network device, for example, periodically reporting the TA report. The TA report may, for example, include a TA value. Based on the TA report, the network device may determine that a collision occurs between uplink transmission UL8 and downlink reception DL4. Accordingly, the network device may refrain from configuring or scheduling downlink reception at the position of downlink reception DL4 to avoid a collision between downlink reception DL4 and uplink transmission UL8. However, a collision actually occurs between uplink transmission UL8 and downlink reception DL2 at the terminal device side. This is caused by a mismatch between the TA value in the TA report and the actual required timing advance. Hereinafter, this situation is referred to as a TA mismatch (or TA discrepancy).

In order to solve this problem, a network device can proactively avoid potential collisions based on the TA report and the maximum TA mismatch value. For example, as shown in FIG. 2, when the maximum TA mismatch value ranges from −2 ms to +2 ms, the network device may avoid scheduling downlink receptions at the DL2, DL3, DL4, DL5, and DL6 which may be conflict with the uplink transmission UL8. However, this approach may result in substantial resource wastage in the NTN network due to the large number of reserved resources.

The time interval from −2 ms to +2 ms, or equivalently the period corresponding to downlink receptions DL2 to DL6, is referred to herein as a “collision ambiguity period.” The shorter the collision ambiguity period, the more flexible uplink and/or downlink scheduling can be. For illustrative purposes, in embodiments of the present disclosure, UL0 to UL9 and DL0 to DL9 correspond to different subframes, which typically have a duration of 1 ms.

In view of this, a method for wireless communications is provided that incorporates relative motion information between a network device and a terminal device to determine the collision ambiguity period for uplink transmission. In this way, collision between uplink transmissions and downlink receptions can be avoided while minimizing resource wastage, thereby preventing throughput degradation at individual terminal devices.

In an embodiment of the present disclosure, in a situation where a collision occurs between an uplink transmission and a downlink reception, the collision ambiguity period can be configured with respect to the uplink transmission, i.e., the collision ambiguity period is set within the uplink transmission interval (or the uplink transmission portion), which is equivalent as a period of cancellinging the uplink transmission that would otherwise cause a collision. Alternatively, the collision ambiguity period can be configured with respect to the downlink reception, i.e., the collision ambiguity period is set within the downlink reception interval (or the downlink reception portion), which is equivalent as a period of cancellinging the downlink reception that would otherwise cause a collision. For example, as shown in FIG. 2, the collision ambiguity period is set with respect to the downlink reception.

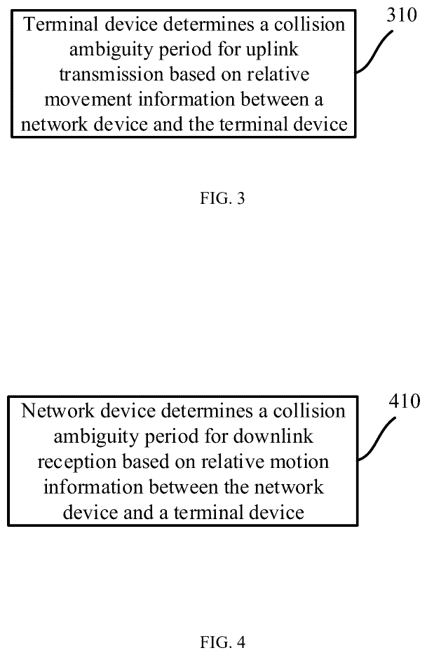

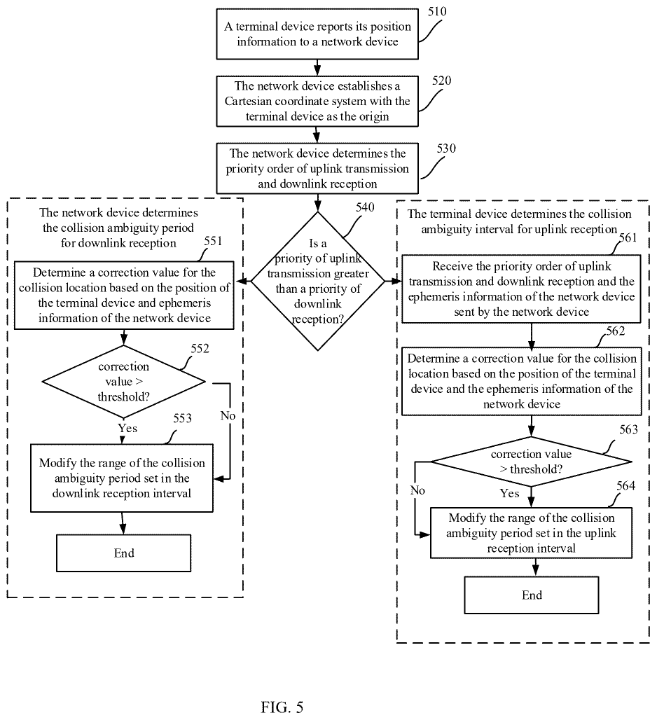

Optionally, the collision ambiguity period for the uplink transmission can be determined by the terminal device, or the collision ambiguity period for the downlink reception can be determined by the network device. The following describes these two cases in conjunction with FIG. 3 and FIG. 4, respectively.

In an embodiment of the present disclosure, the terminal device may be, for example, a lightweight terminal device operating in half-duplex frequency division duplex mode. The network device may be, for example, a network device deployed on a non-terrestrial platform in an NTN network.

FIG. 3 is a schematic diagram of a methods for wireless communications according to an embodiment of the present disclosure. Referring to FIG. 3, in step 310, the terminal device determines, based on relative motion information between the network device and the terminal device, the collision ambiguity period for the uplink transmission.

The collision ambiguity period can be understood as a time interval in which a collision between the uplink transmission and the downlink reception may occur. In other words, the uplink transmission and the downlink reception may collide within the collision ambiguity period.

In this case, the collision ambiguity period for the uplink transmission is configured as a period of cancelling uplink transmission, thereby avoiding the collision between the uplink transmission and the downlink reception.

In an embodiment of the present disclosure, when determining the collision ambiguity period, relative motion between the network device and the terminal device is introduced, thereby optimizing the range of the collision ambiguity period, reducing the duration of the collision ambiguity period, decreasing the occupation of time-frequency resources caused by collision avoidance, improving resource utilization, and reducing the occurrence of reporting TA by the terminal device.

For example, after determining the collision location based on the TA report (reported by the terminal device), the position and length of the collision ambiguity period set within the uplink transmission interval can be determined in conjunction with the relative motion information.

The relative motion information may be used to determine changes in distance and/or moving direction of the network device relative to the terminal device.

In some implementations, the relative motion information includes one or more of the following: position information of the terminal device; position information of the network device; moving velocity of the terminal device; or moving velocity of the network device.

It can be understood that, since the network device in an NTN network is typically deployed on a satellite or other non-terrestrial platform, the moving velocity of the network device is much greater than that of the terminal device. Therefore, in an embodiment of the present disclosure, the movement of the terminal device can be neglected, that is, the moving velocity of the network device is considered to be the relative moving velocity between the network device and the terminal device.

In some implementations, in step 310, the terminal device can determine a correction value for the collision location based on relative motion information between the network device and the terminal device, and determine the collision ambiguity period based on the correction value of the collision location. The collision location is the location where a collision between the uplink transmission and the downlink reception may occur and is determined based on the TA report. In other words, the collision location is determined without considering relative motion between the network device and the terminal device, e.g., the uplink transmission or the downlink reception shown in FIG. 2. The collision location may also be referred to as the collision point center estimated by the terminal device.

In some implementations, the correction value of the collision location is a ratio of a change in a distance between the network device and the terminal device over a predetermined duration to the signal transmission speed.

The predetermined duration may, for example, be a periodicity for reporting TA report by the terminal device, that is, the time interval between two consecutive TA reports by the terminal device. The signal transmission speed refers to the transmission speed of uplink and/or downlink data between the network device and the terminal device, which may, for example, be the speed of light, denoted as c.

The change in the distance between the network device and the terminal device may, for example, be a difference between an initial distance between the network device and the terminal device and a new distance between the network device and the terminal device after the predetermined duration.

In some implementations, the correction value of the collision location is:

$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert .$$

Alternatively, the correction value may also be expressed as

$$Δ TA = \vert \frac{\vec{V} T}{c} \vert ,$$

where \vec{V}T may represent the change in the distance between the network device and the terminal device.

The above ΔTA represents the correction value of the TA. \vec{L_{GNB}} represents the position of the network device in a coordinate system, and \vec{L_{UE}} represents the position of the terminal device in the coordinate system. \vec{V} represents the moving velocity of the network device, T is the predetermined duration, and c is the speed of light. The coordinate system may, for example, be a Cartesian coordinate system. As an example, the coordinate system may be established with the position of the terminal device as the origin of the Cartesian coordinate system. In this case, the position of the terminal device may be the origin or zero.

Optionally, the terminal device may receive configuration information sent by the network device. The configuration information may include priority information for uplink transmission and downlink reception and/or ephemeris information of the network device. The ephemeris information may, for example, include position information and/or moving velocity of the network device.

For example, in scenarios such as remote medical services and emergency alarms, the priority of uplink transmission may be higher than that of downlink reception. In applications such as sensor networks and cameras, the priority of downlink reception may be higher than that of uplink transmission.

The terminal device may, for example, obtain its own position information \vec{L_{UE}} through GPS or other means and report its position information \vec{L_{UE}} to the network device, for example, by location report signaling. If the priority of uplink transmission is higher than that of downlink reception, the terminal device may not perform the above operation. If the priority of downlink reception is higher than that of uplink transmission, the terminal device performs the above operation. For example, after receiving configuration information sent by the network device, the terminal device may estimate a correction value of the collision location based on the position information \vec{L_{UE}} of the terminal device, the position information \vec{L_{GNB}} of the network device, the speed \vec{V} of the network device, the time interval T between two consecutive TA reports, and/or other relevant information. Specifically, the initial distance |\vec{L_{GNB}}−\vec{L_{UE}}| between the terminal device and the network device may be calculated based on the position information \vec{L_{UE}} of the terminal device and the position information \vec{L_{GNB}} of the network device. Then, based on the moving velocity \vec{V} of the network device, a new distance after one TA report periodicity may be calculated, that is, |\vec{L_{GNB}}+\vec{V}T−\vec{L_{UE}}|. Finally, the difference between the initial distance and the new distance after one TA report periodicity is calculated, and this difference is divided by the speed of light c to obtain the correction value ΔTA=

$$\vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert$$

of the collision location. Thereafter, the terminal device may determine the collision ambiguity period based on the correction value and the direction of relative motion between the network device and the terminal device.

It can be understood that, if a collision ambiguity period has been determined based on the collision location determined from the TA report and the maximum TA mismatch value, for example, the collision ambiguity period shown in FIG. 2, the terminal device may modify (or reconfigure) the collision ambiguity period within the uplink transmission interval based on the correction value of the collision location, thereby optimizing the range of the collision ambiguity period to improve resource utilization. In some cases, the terminal device may also not modify the collision ambiguity period.

For example, when the correction value of the collision location is smaller than a threshold, the terminal device may determine the collision ambiguity period based on the collision location before correction, that is, based on the collision location determined from the TA report, for example, the collision ambiguity period shown in FIG. 2. After the terminal device determines the correction value, if the correction value is smaller than the threshold, the terminal device may not use the correction value to modify the collision ambiguity period.

For example, when the correction value of the collision location is greater than or equal to a threshold, the terminal device may determine the collision ambiguity period based on the collision location determined from the TA report and the correction value of the collision location, for example, a collision ambiguity period different from that shown in FIG. 2. After determining the correction value, if the correction value is greater than the threshold, the terminal device uses the correction value to modify the original collision ambiguity period, for example, the collision ambiguity period shown in FIG. 2, in order to optimize the range of the collision ambiguity period.

In some implementations, when the network device and the terminal device are moving toward each other, the collision ambiguity period is [TA0−ΔTA, TA0]. When the network device and the terminal device are moving away from each other, the collision ambiguity period is [TA0, TA0+ΔTA]. Here, TA0 represents the collision location, and ΔTA represents the correction value of the collision location.

The relative motion between the network device and the terminal device includes two cases. In one case, the network device and the terminal device are moving toward each other, in which the distance between the network device and the terminal device gradually decreases. Therefore, the collision ambiguity period may be set as [TA0−ΔTA, TA0]. In the other case, the network device and the terminal device are moving away from each other, in which the distance between the network device and the terminal device gradually increases. Therefore, the collision ambiguity period may be set as [TA0, TA0+ΔTA]. Here, TA0 is the collision location estimated based on the TA report, or in other words, the collision location determined without considering the relative motion between the network device and the terminal device.

In some implementations, when a first angle is less than 90°, the network device and the terminal device are moving toward each other. When the first angle is greater than 90°, the network device and the terminal device are moving away from each other. The first angle is the angle between the moving direction of the network device and the line connecting the network device and the terminal device. For example, in a Cartesian coordinate system established with the position of the terminal device as the origin, the angle between the moving direction of the network device and the line connecting the position of the network device and the position of the terminal device is the first angle. When the first angle is greater than 90°, it indicates that the network device and the terminal device are moving away from each other, that is, the distance between the network device and the terminal device is rapidly increasing. When the first angle is less than 90°, it indicates that the network device and the terminal device are moving toward each other, that is, the distance between the network device and the terminal device is rapidly decreasing.

In some implementations, the terminal device further sends its position information to the network device. The position information of the terminal device may, for example, be used by the network device to determine a collision ambiguity period for downlink reception, where the collision ambiguity period for the downlink reception is configured as a period of cancelling downlink reception. The position information of the terminal device may also, for example, be used by the network device to establish a corresponding coordinate system, which facilitates representation of the positions and velocities of the network device and the terminal device.

In some implementations, the terminal device may periodically report its position information. Alternatively, the terminal device may send updated position information to the network device when its position changes. For example, when the position of the terminal device changes within a predetermined time interval, the terminal device may send the updated position information to the network device. The updated position information may, for example, be reported through location update signaling.

The above describes the process by which the terminal device determines the collision ambiguity period for uplink transmission. The following describes the process by which the network device determines the collision ambiguity period for downlink reception.

FIG. 4 is a flow diagram of a method for wireless communications according to an embodiment of the present disclosure. Referring to FIG. 4, in step 410, the network device determines the collision ambiguity period for downlink reception based on relative motion information between the network device and the terminal device.

The collision ambiguity period may be understood as a time period during which a collision may occur between uplink transmission and downlink reception. In other words, uplink transmission and downlink reception may collide within the collision ambiguity period.

The collision ambiguity period for downlink reception is configured as a period of cancelling downlink reception, thereby avoiding a collision between uplink transmission and downlink reception.

In the embodiment of the present disclosure, relative motion between the network device and the terminal device is introduced when determining the collision ambiguity period, thereby optimizing the range of the collision ambiguity period, reducing the duration of the collision ambiguity period, reducing the occupation of time-frequency resources caused by collision avoidance, improving resource utilization, and reducing the occurrence of reporting TA by the terminal device.

For example, after determining the collision location based on the TA report (that is, TA reported by the terminal device), the position and length of the collision ambiguity period set within the downlink reception interval can be determined in combination with the relative motion information.

The relative motion information may, for example, be used to determine the change in distance and/or moving direction of the network device relative to the terminal device.

In some implementations, the relative motion information includes one or more of the following: position information of the terminal device; position information of the network device; a moving velocity of the terminal device; or a moving velocity of the network device.

It can be understood that, since the network device in an NTN network is typically deployed on a satellite or other non-terrestrial platform, the moving velocity of the network device is much greater than that of the terminal device. Therefore, in an embodiment of the present disclosure, the movement of the terminal device can be neglected, that is, the moving velocity of the network device is considered to be the relative moving velocity between the network device and the terminal device.

In some implementations, in step 410, the network device may determine a correction value of the collision location based on relative motion information between the network device and the terminal device, and determine the collision ambiguity period based on the correction value of the collision location. The collision location is a location where uplink transmission and downlink reception collide, determined based on the TA report. In other words, the collision location is determined without considering relative motion between the network device and the terminal device, e.g., the uplink transmission UL8 or the downlink reception DL4 shown in FIG. 2. The collision location may also be referred to as the collision point center estimated by the terminal device.

In some implementations, the correction value of the collision location is a ratio of the change in the distance between the network device and the terminal device over a predetermined duration to the signal transmission speed.

The predetermined duration may, for example, be a periodicity for reporting TA report by the terminal device, that is, the time interval between two consecutive TA reports by the terminal device. The signal transmission speed refers to the transmission speed of uplink and/or downlink data between the network device and the terminal device, which may, for example, be the speed of light, denoted as c.

The change in the distance between the network device and the terminal device may, for example, be a difference between an initial distance between the network device and the terminal device and a new distance between the network device and the terminal device after the predetermined duration.

In some implementations, the correction value of the collision location is:

$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert .$$

Alternatively, the correction value may also be expressed as

$$Δ TA = \vert \frac{\vec{V} T}{c} \vert ,$$

where \vec{V}T may represent the change in the distance between the network device and the terminal device.

The above ΔTA represents the correction value of the TA. \vec{L_{GNB}} represents the position of the network device in a coordinate system, and \vec{L_{UE}} represents the position of the terminal device in the coordinate system. \vec{V} represents the moving velocity of the network device, T is the predetermined duration, and c is the speed of light. The coordinate system may, for example, be a Cartesian coordinate system. As an example, the coordinate system may be established with the position of the terminal device as the origin of the Cartesian coordinate system. In this case, the position of the terminal device may be the origin or zero.

Optionally, the network device may receive position information of the terminal device reported by the terminal device. Based on the position information reported by the terminal device, and in combination with priority information for uplink transmission and downlink reception and/or ephemeris information of the network device, the collision ambiguity period for downlink reception can be determined. The ephemeris information may, for example, include information regarding the position and/or moving velocity of the network device.

For example, in scenarios such as remote medical services and emergency alarms, the priority of uplink transmission may be higher than that of downlink reception. In applications such as sensor networks and cameras, the priority of downlink reception may be higher than that of uplink transmission.

The network device may, for example, calculate information regarding the direction and speed of relative motion between the network device and the terminal device based on the position information reported by the terminal device, and store this information in a memory for subsequent use. The network device may construct a Cartesian coordinate system with the terminal device as the origin based on the position information \vec{L_{UE}} of the terminal device in combination with the ephemeris information of the network device. The position coordinates of the terminal device are denoted as \vec{L_{UE}}, the position coordinates of the network device are denoted as \vec{L_{GNB}}, and the moving velocity of the network device is denoted as \vec{V}. If the priority of downlink reception is higher than that of uplink transmission, the network device may not perform the above operation. If the priority of uplink transmission is higher than that of downlink reception, the network device performs the above operation. For example, the network device may estimate a correction value of the collision location based on the position information \vec{L_{UE}} of the terminal device, the position information \vec{L_{GNB}} of the network device, the moving velocity \vec{V} of the network device, and the time interval T between two consecutive TA reports, and/or other relevant information. Specifically, the initial distance |\vec{L_{GNB}}−\vec{L_{UE}}| between the terminal device and the network device may be calculated based on the position information \vec{L_{UE}} of the terminal device and the position information \vec{L_{GNB}} of the network device. Then, based on the moving velocity \vec{V} of the network device, a new distance after one TA report periodicity may be calculated, that is, |\vec{L_{GNB}}+\vec{V}T−\vec{L_{UE}}|. Finally, the difference between the initial distance and the new distance after one TA report periodicity is calculated, and this difference is divided by the speed of light c to obtain the correction value

$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert$$

of the collision location. Thereafter, the network device may determine the collision ambiguity period based on the correction value and the direction of relative motion between the network device and the terminal device.

It can be understood that if the collision ambiguity period has already been determined based on the collision location determined from the TA report and the maximum TA mismatch value, for example, the collision ambiguity period shown in FIG. 2, the network device may modify (or reconfigure) the collision ambiguity period within the downlink reception interval based on the correction value of the collision location, thereby optimizing the range of the collision ambiguity period to improve resource utilization. In some cases, the network device may not modify the collision ambiguity period.

For example, when the correction value of the collision location is less than a threshold, the network device may determine the collision ambiguity period based on the collision location prior to correction, that is, the collision location determined from the TA report, for example, the collision ambiguity period shown in FIG. 2. After determining the correction value, if the correction value is less than the threshold, the network device may not use the correction value to modify the collision ambiguity period.

In another example, when the correction value of the collision location is greater than or equal to the threshold, the network device may determine the collision ambiguity period based on the collision location determined from the TA report and the correction value of the collision location, for example, a collision ambiguity period different from that shown in FIG. 2. After determining the correction value, if the correction value is greater than the threshold, the network device uses the correction value to modify the original collision ambiguity period, for example, the collision ambiguity period shown in FIG. 2, so as to optimize the range of the collision ambiguity period.

In some implementations, when the network device and the terminal device are moving toward each other, the collision ambiguity period is [TA0, TA0+ΔTA]. When the network device and the terminal device are moving away from each other, the collision ambiguity period is [TA0−ΔTA, TA0]. Here, TA0 represents the collision location, and ΔTA represents the correction value of the collision location.

The relative motion between the network device and the terminal device includes two cases. In one case, the network device and the terminal device are moving toward each other, in which case the distance between the network device and the terminal device gradually decreases, and thus the collision ambiguity period may be set to [TA0−ΔTA, TA0]. In another case, the network device and the terminal device are moving away from each other, in which case the distance between the network device and the terminal device gradually increases, and thus the collision ambiguity period may be set to [TA0, TA0+ΔTA]. Here, TA0 is the collision location estimated based on timing advance information, or in other words, the collision location determined without considering the relative motion between the network device and the terminal device.

In some implementations, when a first angle is less than 90°, the network device and the terminal device are moving toward each other. When the first angle is greater than 90°, the network device and the terminal device are moving away from each other. Here, the first angle is the angle between the moving direction of the network device and the line connecting the network device and the terminal device. For example, in a Cartesian coordinate system established with the position of the terminal device as the origin, the first angle is the angle between the moving direction of the network device and the line connecting the positions of the network device and the terminal device. When the first angle is greater than 90°, it indicates that the network device and the terminal device are moving away from each other, that is, the distance between the network device and the terminal device rapidly increases. When the first angle is less than 90°, it indicates that the network device and the terminal device are moving toward each other, that is, the distance between the network device and the terminal device rapidly decreases.

In some implementations, the network device may also transmit configuration information to the terminal device. The configuration information includes priority information for uplink transmission and downlink reception and/or ephemeris information of the network device. The ephemeris information may, for example, include position information and/or moving velocity of the network device. The configuration information may, for example, be used by the terminal device to determine the collision ambiguity period for uplink transmission, where the collision ambiguity period for uplink transmission is configured as period of cancelling uplink transmission.

For example, FIG. 5 illustrates a process in which the terminal device and the network device respectively determine the collision ambiguity periods for uplink transmission and downlink reception. As shown in FIG. 5, based on the priority information for uplink transmission and downlink reception, it can be determined whether to modify the collision ambiguity period set within the uplink transmission interval or within the downlink reception interval.

In step 510, the terminal device reports its position information to the network device.

In step 520, the network device establishes a Cartesian coordinate system with the terminal device as the origin.

In step 530, the network device determines the priority order of uplink transmission and downlink reception.

In step 540, it is determined whether the priority of uplink transmission is higher than the priority of downlink reception.

If it is determined in step 540 that the priority of uplink transmission is higher than the priority of downlink reception, steps 551 to 553 are performed.

In step 551, the network device determines the correction value of the collision location based on the position of the terminal device and the ephemeris information of the network device.

In step 552, the network device determines whether the correction value is greater than a threshold. Step 552 is optional.

If the correction value is greater than the threshold, step 553 is performed.

In step 553, the network device modifies the range of the collision ambiguity period set within the downlink reception interval.

If it is determined in step 540 that the priority of downlink reception is higher than the priority of uplink transmission, steps 561 to 564 are performed.

In step 561, the terminal device receives signaling transmitted by the network device, which carries the priority order of uplink transmission and downlink reception, as well as the ephemeris information of the network device.

In step 562, the terminal device determines the correction value of the collision location based on its position information and the ephemeris information of the network device.

In step 563, the terminal device determines whether the correction value is greater than a threshold. Step 563 is optional.

If the correction value is greater than the threshold, step 564 is performed.

In step 564, the terminal device modifies the range of the collision ambiguity period set within the uplink transmission interval.

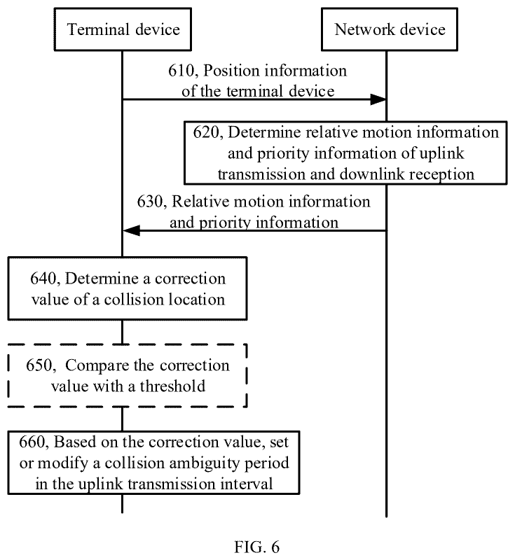

The following describes the present embodiment in more detail with reference to specific examples. It should be noted that the examples shown in FIG. 5 through FIG. 8 are provided solely to assist persons skilled in the art in understanding the present embodiment and are not intended to limit the present embodiment to the specific numerical values or scenarios illustrated. Those skilled in the art, based on the examples shown in FIG. 6 through FIG. 13, can obviously make various equivalent modifications or variations, and such modifications or variations also fall within the scope of the present embodiment.

Referring to FIG. 6 to FIG. 9, assuming that the priority of downlink reception is higher than the priority of uplink transmission, the collision ambiguity period is set within the uplink transmission interval. As shown in FIG. 6, in step 610, the network device receives the position information reported by the terminal device.

In step 620, the network device obtains relative motion information. The network device also determines the priority information of uplink transmission and downlink reception.

The network device may, in combination with the position coordinates of the terminal device and its own ephemeris information, establish a Cartesian coordinate system with the terminal device as the origin. Based on the established coordinate system, the network device may determine relative motion information. For example, the position coordinates of the terminal device are denoted as \vec{L_{UE}}, the position coordinates of the network device are denoted as \vec{L_{GNB}}, and the motion velocity of the network device is denoted as \vec{V}.

The first angle between the moving direction of the network device and the line connecting the network device and the terminal device being less than 90° indicates that the network device and the terminal device are moving toward each other. The first angle between the moving direction of the network device and the line connecting the network device and the terminal device being greater than 90° indicates that the network device and the terminal device are moving away from each other.

Since the priority of downlink reception is higher, the terminal device preferentially performs downlink reception, and set a collision ambiguity interval in the uplink transmission interval, that is, when uplink transmission and downlink reception may collide, the uplink transmission at the position where the collision may occur is cancelled.

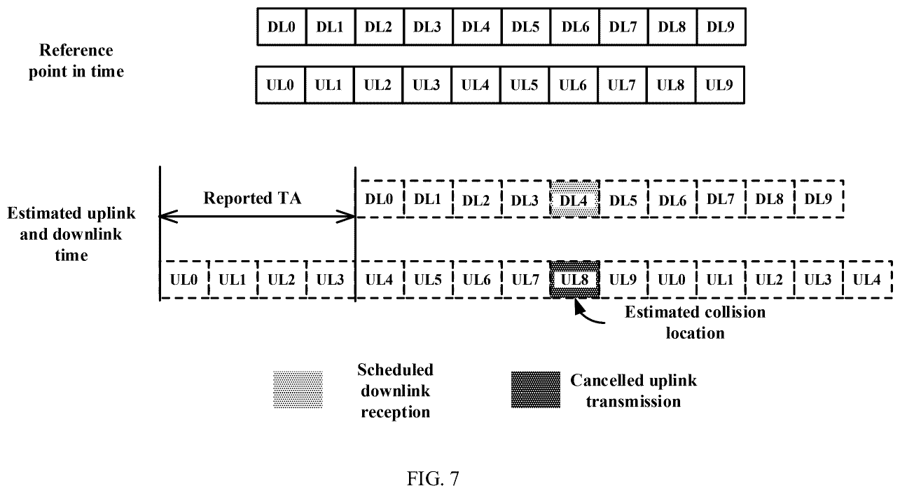

For example, as shown in FIG. 7, when a collision occurs between uplink transmission UL8 and downlink reception DL4, the uplink transmission UL8 may be cancelled so as to avoid a collision with the downlink reception DL4. Hereinafter, the position of the uplink transmission UL8 is referred to as a collision location TA0, which may, for example, be determined based on a TA report.

In step 630, the network device transmits to the terminal device the position coordinates \vec{L_{UE}} of the terminal device, the position coordinates \vec{L_{GNB}} of the network device, the moving velocity \vec{V} of the network device, the priority information of uplink transmission and downlink reception, and the like.

In step 640, the terminal device determines a correction value ΔTA of the collision location based on the position coordinates \vec{L_{UE}} of the terminal device, the position coordinates \vec{L_{GNB}} of the network device, the moving velocity \vec{V} of the network device, and a time interval T between two consecutive TA reports.

Next, step 650 or step 660 is performed. That is, step 650 is optional.

In step 650, the terminal device compares the correction value ΔTA with a threshold.

When the correction value ΔTA is greater than the threshold, step 660 is performed.

In step 660, the terminal device, based on the correction value ΔTA, sets a collision ambiguity period within the uplink transmission interval, or modifies a collision ambiguity period in the uplink transmission interval.

There are two cases. If the network device and the terminal device are moving toward each other, the collision ambiguity period is [TA0−ΔTA, TA0]. If the network device and the terminal device are moving away from each other, the collision ambiguity period is [TA0, TA0+ΔTA].

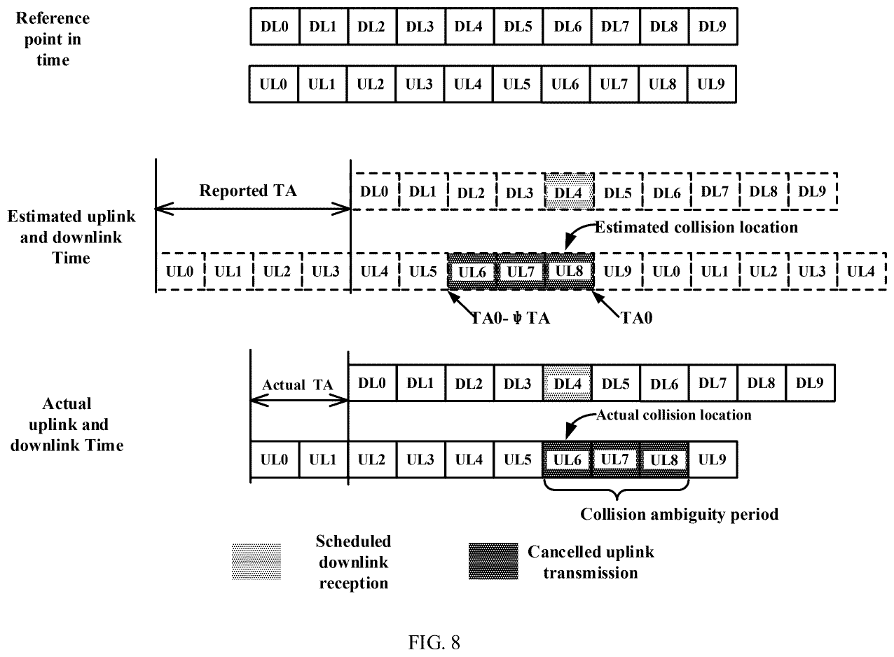

For example, as shown in FIG. 8, the collision location TA0 corresponds to the position of the uplink transmission UL8. Assuming that the correction value ΔTA calculated in step 640 is 2 ms (or two subframes), and that the network device and the terminal device are moving toward each other, the collision ambiguity period includes uplink transmissions UL6, UL7, and UL8. That is, the terminal device does not transmit uplink data at UL6, UL7, and UL8, thereby avoiding a potential collision with downlink reception during this period.

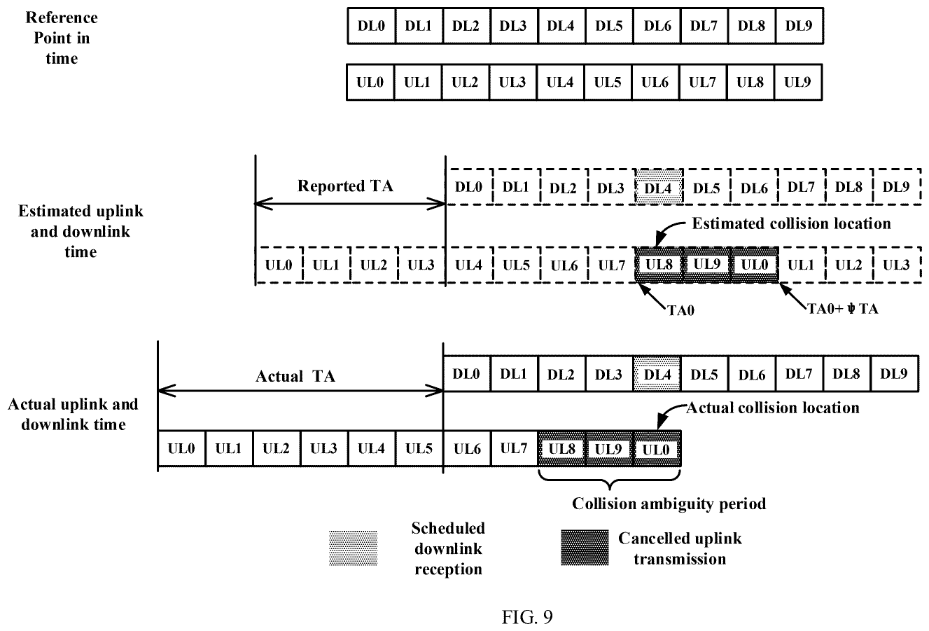

In another example, as shown in FIG. 9, the collision location TA0 corresponds to the position of the uplink transmission UL8. Assuming that in step 640 the calculated ΔTA is 2 ms (i.e., 2 subframes), and that the network device and the terminal device are moving away from each other, then the collision ambiguity period includes uplink transmissions UL8, UL9, and UL10. In other words, the terminal device does not transmit uplink data at UL8, UL9, and UL10, thereby avoiding a potential collision with downlink reception during this period.

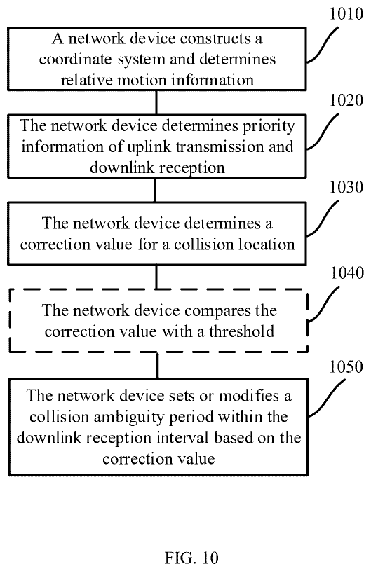

Referring to FIG. 10 to FIG. 13, it is assumed that the priority of uplink transmission is higher than that of downlink reception. In this case, the collision ambiguity period is set in the downlink reception interval. As shown in FIG. 10, in step 1010, the network device constructs a Cartesian coordinate system with the terminal device as the origin, based on the location information of the terminal device reported by the terminal device and in combination with its own ephemeris information. The network device then determines relative motion information within this coordinate system.

The relative motion information may include, for example, the position coordinates of the terminal device denoted as \vec{L_{UE}}, the position coordinates of the network device denoted as \vec{L_{GNB}}, and the moving velocity of the network device denoted as \vec{V}.

The first angle between the moving direction of the network device and the line connecting the network device and the terminal device being less than 90° indicates that the network device and the terminal device are approaching each other. The first angle between the moving direction of the network device and the line connecting the network device and the terminal device being greater than 90° indicates that the network device and the terminal device are moving away from each other.

In step 1020, the network device determines priority information for uplink transmission and downlink reception.

Since the priority of uplink transmission is higher, the terminal device preferentially transmits uplink data. Accordingly, the network device sets a collision ambiguity period in the downlink reception interval. That is, when a collision may occur between uplink transmission and downlink reception, the downlink reception at the potentially colliding location is canceled.

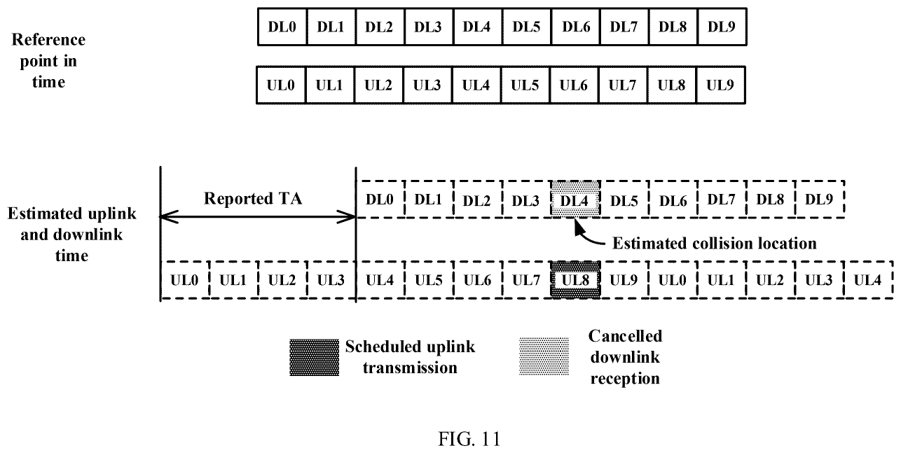

For example, as shown in FIG. 11, a collision occurs between uplink transmission UL8 and downlink reception DL4. In this case, downlink reception DL4 can be canceled to avoid a collision with uplink transmission UL8. Here, the position of downlink reception DL4 is referred to as the collision location TA0, which can, for example, be determined based on a TA report.

In step 1030, the network device calculates a correction value ΔTA of the collision location TA0 based on position coordinates \vec{L_{UE}} of the terminal device, the position coordinates \vec{L_{GNB}} of the network device, the moving velocity \vec{V} of the network device, and a time interval T between two consecutive TA reports.

Next, step 1040 or step 1050 is performed. That is, step 1040 is optional.

In step 1040, the network device compares the correction value ΔTA with a threshold. If the correction value ΔTA is greater than the threshold, step 1050 is performed.

In step 1050, the network device sets a collision ambiguity period in the downlink reception interval, or modifies the collision ambiguity period in the downlink reception interval, based on the correction value ΔTA.

There are two cases. If the network device and the terminal device are moving toward each other, the collision ambiguity period is [TA0, TA0+ΔTA]. If the network device and the terminal device are moving away from each other, the collision ambiguity period is [TA0−ΔTA, TA0].

For example, as shown in FIG. 12, the collision location TA0 corresponds to the downlink reception DL4. Assuming that ΔTA is 2 ms (or 2 subframes) and the network device and the terminal device are moving toward each other, the collision ambiguity period includes downlink receptions DL2, DL3, and DL4. That is, the network device does not transmit downlink data at the positions of DL2, DL3, and DL4, thereby avoiding possible collisions with uplink transmissions during this period.

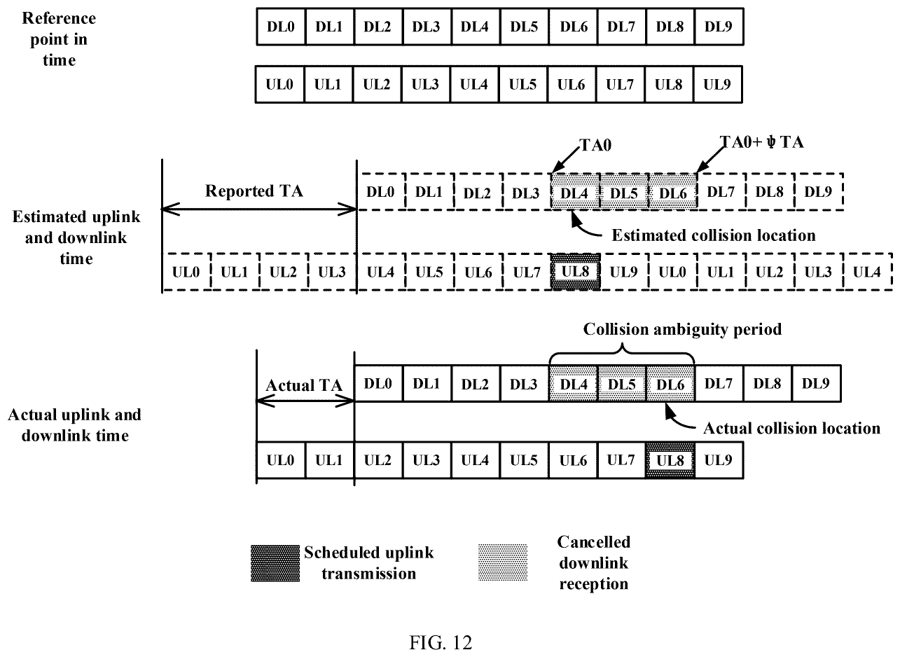

As another example, as shown in FIG. 13, the collision location TA0 corresponds to the downlink reception DL4. Assuming that ΔTA is 2 ms (or 2 subframes) and the network device and the terminal device are moving away from each other, the collision ambiguity period includes downlink receptions DL4, DL5, and DL6. That is, the network device does not transmit downlink data at the positions of DL4, DL5, and DL6, thereby avoiding possible collisions with uplink transmissions during this period.

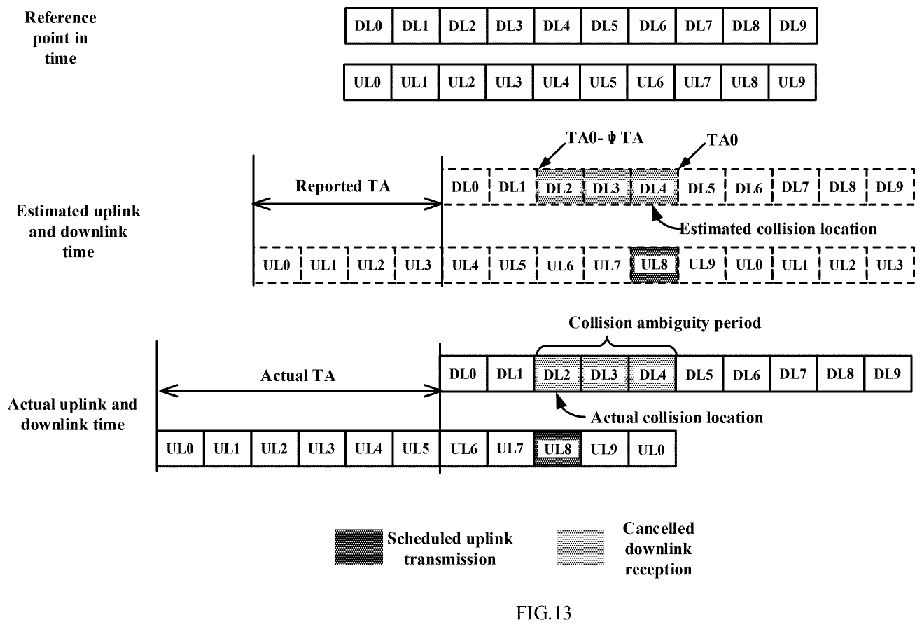

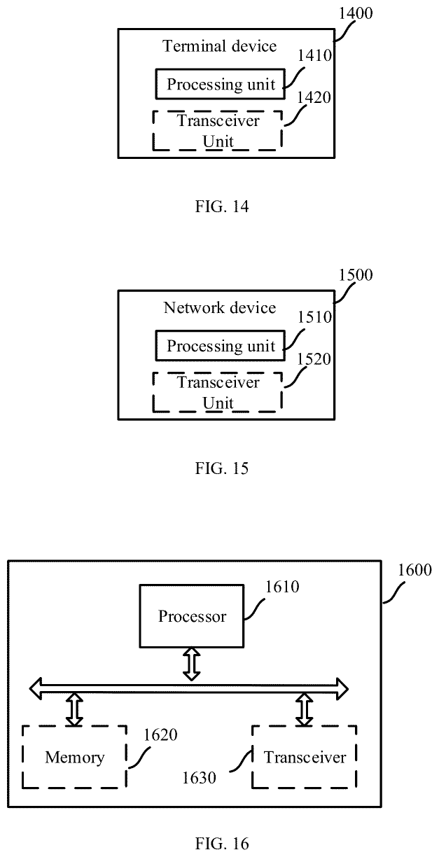

The method embodiments of the present disclosure have been described in detail with reference to FIGS. 1 to 13. Next, the device embodiments of the present disclosure will be described in detail with reference to FIGS. 14 to 16. It should be understood that the descriptions of the method embodiments correspond to the device embodiments, and the portions not described in detail can refer to the preceding method embodiments.

FIG. 14 is a schematic structural diagram illustrating a terminal device according to an embodiment of the present disclosure. As shown in FIG. 14, the terminal device 1400 may include a processing unit 1410. The processing unit 1410 is configured to determine a collision ambiguity period for an uplink transmission based on relative motion information between a network device and the terminal device, where the collision ambiguity period is configured as a period of cancelling uplink transmission.

In some implementations, the relative motion information includes one or more of the following: position information of the terminal device; position information of the network device; a moving velocity of the terminal device; and a moving velocity of the network device.

In some implementations, the processing unit 1410 is specifically configured to: determine a correction value of a collision location based on the relative motion information, where the collision location corresponds to a location at which the uplink transmission and a downlink reception collide as determined based on a timing advance TA report; and determine the collision ambiguity period based on the correction value of the collision location.

In some implementations, the correction value of the collision location is a ratio of a change in a distance between the network device and the terminal device over a predetermined duration to the signal transmission speed.

In some implementations, the correction value of the collision location is:

$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert .$$

ΔTA represents the correction value of the TA. \vec{L_{GNB}} represents a position of the network device in a coordinate system, and \vec{L_{UE}} represents a position of the terminal device in the coordinate system. The coordinate system is a Cartesian coordinate system established with the position of the terminal device as a reference point. \vec{V} represents the moving velocity of the network device, T represents the predetermined duration, and c represents the speed of light.

In some implementations, the predetermined duration is equal to a periodicity for reporting the TA report by the terminal device.

In some implementations, when the network device and the terminal device are moving toward each other, the collision ambiguity period is [TA0−ΔTA, TA0]. When the network device and the terminal device are moving away from each other, the collision ambiguity period is [TA0, TA0+ΔTA]. TA0 represents the collision location, and ΔTA represents a correction value of the collision location.

In some implementations, when a first angle is less than 90°, the network device and the terminal device are determined as moving toward each other. When the first angle is greater than 90°, the network device and the terminal device are determined as moving away from each other. The first angle is an angle between a moving direction of the network device and a line connecting the network device and the terminal device.

In some implementations, the processing unit 1410 is configured to: determine the collision ambiguity period based on the collision location obtained before correction when the correction value of the collision location is less than a threshold; and determine the collision ambiguity period based on the collision location obtained before correction and the correction value of the collision location when the correction value of the collision location is greater than or equal to the threshold.

In some implementations, the priority of downlink reception is higher than the priority of the uplink transmission.

In some implementations, the terminal device further includes a transceiver unit 1420 configured to receive configuration information sent by the network device, wherein the configuration information includes the priority information of the uplink transmission and the downlink reception and/or ephemeris information of the network device, and the ephemeris information includes a position and/or a moving velocity of the network device.

In some implementations, the terminal device further includes the transceiver unit 1420 configured to transmit the position information of the terminal device to the network device, wherein the position information of the terminal device is used by the network device to determine a collision ambiguity period for the downlink reception, and the collision ambiguity period is configured as a period of cancelling the downlink reception.

In some implementations, the transceiver unit 1420 is specifically configured to transmit the position information of the terminal device to the network device in response to a change in the position of the terminal device within a predetermined time interval.

In some implementations, the terminal device is a lightweight terminal device in a half-duplex frequency division duplex mode; and/or the network device is a network device disposed on a non-terrestrial platform in an NTN.

It is understood that the processing unit 1410 may be, for example, a processor 1610. Additionally, optionally, the terminal device 1400 further includes a transceiver 1630 and a memory 1620, as illustrated in FIG. 16.

FIG. 15 is a schematic structural diagram illustrating a network device according to an embodiment of the present disclosure. The network device 1500 shown in FIG. 15 may include a processing unit 1510. The processing unit 1510 is configured to determine a collision ambiguity period for downlink reception based on relative motion information between the network device and the terminal device, wherein the collision ambiguity period is configured as a period of cancelling the downlink reception.

In some implementations, the relative motion information includes one or more of the following: position information of the terminal device; position information of the network device; a moving velocity of the terminal device; and a moving velocity of the network device.

In some implementations, the processing unit 1510 is specifically configured to: determine a correction value of collision location based on the relative motion information, wherein the collision location is a position where a downlink reception and an uplink transmission collide as determined based on a timing advance TA report; and determine the collision ambiguity period based on the correction value.

In some implementations, the correction value of the collision location is a ratio of a change in a distance between the network device and the terminal device over a predetermined duration to the signal transmission speed.

In some implementations, the correction value of the collision location is:

$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert .$$

ΔTA represents the correction value of the TA. \vec{L_{GNB}} represents a position of the network device in a coordinate system, and \vec{L_{UE}} represents a position of the terminal device in the coordinate system. The coordinate system is a Cartesian coordinate system established with the position of the terminal device as a reference point. \vec{V} represents a moving velocity of the network device, T represents the predetermined duration, and c represents the speed of light.

In some implementations, the predetermined duration is equal to a periodicity for reporting the TA report by the terminal device.

In some implementations, when the network device and the terminal device are moving toward each other, the collision ambiguity period is [TA0, TA0+ΔTA]. When the network device and the terminal device are moving away from each other, the collision ambiguity period is [TA0−ΔTA, TA0]. TA0 represents the collision location and ΔTA represents the correction value of the collision location.

In some implementations, when a first angle is less than 90°, the network device and the terminal device are determined as moving toward each other. When the first angle is greater than 90°, the network device and the terminal device are determined as moving away from each other. The first angle is an angle between a moving direction of the network device and a line connecting the network device and the terminal device.

In some implementations, the processing unit 1510 is specifically configured to: determine the collision ambiguity period based on the collision location obtained before correction when the correction value of the collision location is less than a threshold; and determine the collision ambiguity period based on the collision location obtained before correction and the correction value of the collision location when the correction value of the collision location is greater than or equal to the threshold.

In some implementations, the network device further includes a transceiver unit 1520 configured to receive position information of the terminal device reported by the terminal device.

In some implementations, the network device further includes the transceiver unit 1520 configured to transmit configuration information to the terminal device, wherein the configuration information includes priority information of uplink transmission and the downlink reception and/or ephemeris information of the network device, and the ephemeris information includes a position and/or a moving velocity of the network device. The configuration information is used by the terminal device to determine a collision ambiguity period for uplink transmission, wherein the collision ambiguity period is configured as a period of cancelling the uplink transmission.

In some implementations, the terminal device is a lightweight terminal device in a half-duplex frequency division duplex mode; and/or the network device is a network device disposed on a non-terrestrial platform in an NTN.

It can be understood that the processing unit 1510 may, for example, be a processor 1610. Additionally, optionally, the network device 1500 may further include a transceiver 1630 and a memory 1620, as illustrated in FIG. 16.

FIG. 16 is a schematic diagram illustrating a communications device according to an embodiment of the present disclosure. In FIG. 16, dashed lines indicate that the unit or module is optional. The device 1600 may be configured to implement the method described in the above-described method embodiments. For example, the device 1600 may be a chip, a terminal device, or a network device.

The device 1600 may include one or more processors 1610. The processor 1610 may support the device 1600 in implementing the method described in the foregoing method embodiments. The processor 1610 may be a general-purpose processor or a special-purpose processor. For example, the processor 1610 may be a central processing unit (CPU). Alternatively, the processor 1610 may be another general-purpose processor, a digital signal processor (DSP), an application-specific integrated circuit (ASIC), a field programmable gate array (FPGA) or other programmable logic device, discrete gates or transistor logic devices, discrete hardware components, and the like. The general-purpose processor may be a microprocessor or any conventional processor.

The device 1600 may further include one or more memories 1620. The memory 1620 store a program that can be executed by the processor 1610, such that the processor 1610 perform the method described in the above method embodiments. The memory 1620 may be independent of the processor 1610 or may be integrated with the processor 1610.

The device 1600 may further include a transceiver 1630. The processor 1610 may communicate with other devices or chips via the transceiver 1630. For example, the processor 1610 may transmit and receive data to or from other devices or chips through the transceiver 1630.

The present embodiment also provides a communications system. The communications system includes the above-described terminal device and network device. In some embodiments, the system may further include other devices that interact with the terminal device and the network device.

The present embodiment also provides a computer-readable storage medium for storing a program. The computer-readable storage medium may be applied to the terminal device or network device provided in the present embodiment, and the program causes a computer to execute the method performed by the terminal device or network device in various embodiments of the present disclosure.

The present embodiment further provides a computer program product. The computer program product includes a program. The computer program product may be applied to the terminal device or network device provided in the present embodiment, and the program causes a computer to execute the method performed by the terminal device or network device in various embodiments of the present disclosure.

The present embodiment also provides a computer program. The computer program may be applied to the terminal device or network device provided in the present embodiment, and the computer program causes a computer to execute the method performed by the terminal device or network device in various embodiments of the present disclosure.

It should be understood that in the present embodiment, the terms “system” and “network” may be used interchangeably. Furthermore, the terms used in the present disclosure are intended only to describe specific embodiments and are not intended to limit the present disclosure. In the specification, claims, and accompanying drawings, terms such as “first,” “second,” “third,” and “fourth” are used to distinguish different objects and are not intended to indicate a specific order. In addition, the terms “comprising” and “having,” as well as any of their variations, are intended to cover non-exclusive inclusion.

In the embodiments of the present disclosure, the term “indicate” may refer to a direct indication, an indirect indication, or an indication of association. For example, “A indicates B” may mean that A directly indicates B, e.g., B can be obtained from A; it may also mean that A indirectly indicates B, e.g., A indicates C and B can be obtained from C; or it may mean that A and B have an association.

In the embodiments of the present disclosure, “B corresponding to A” indicates that B is associated with A and can be determined based on A. It should also be understood that determining B based on A does not mean B is determined solely based on A; B may be determined based on A and/or other information.

In the embodiments of the present disclosure, the term “corresponding” may indicate a direct or indirect correspondence, may indicate an association, or may refer to relationships such as indicating and being indicated, or configuring or being configured.

In the embodiments of the present disclosure, “predefined” or “preconfigured” can be implemented by pre-storing corresponding code, tables, or other information in a device (e.g., including a terminal device and a network device) that can be used to indicate relevant information. The present disclosure does not limit the specific implementation. For example, “predefined” may refer to definitions in a protocol.

In the embodiments of the present disclosure, the term “protocol” may refer to standard protocols in the field of communications, and may include, for example, the LTE protocol, NR protocol, as well as relevant protocols applicable to future communications systems. The present disclosure is not limited thereto.

In the embodiments of the present disclosure, the term “and/or” is merely used to describe an association between objects and indicates that three types of relationships may exist. For example, “A and/or B” may indicate: only A exists, both A and B exist, or only B exists. In addition, the character “/” used herein generally represents an “or” relationship between the associated objects.

In the various embodiments of the present disclosure, the numerical order of the processes does not imply a sequential order of execution. The execution sequence of the processes should be determined based on their functions and intrinsic logic, and should not be construed as limiting the implementation of the embodiments of the present disclosure.

It should be understood that in the embodiments provided herein, the disclosed system, device, and method can be implemented in other manners. For example, the device embodiments described above are merely illustrative. The division of units is only a logical functional division. In actual implementation, there may be other division schemes, such as multiple units or components being combined or integrated into another system, or some features may be omitted or not executed. Furthermore, any coupling or direct coupling or communication connection shown or discussed may be indirect coupling or communication connection through some interfaces, devices or units, and may be electrical, mechanical, or in other forms.

The units described as separate components may or may not be physically separated. The units shown as units may or may not be physical units; they may be located at one place or distributed into multiple network units. All or part of the units can be selected according to actual needs to achieve the objectives of the embodiments of the present disclosure.

Moreover, in the various embodiments of the present disclosure, the functional units may be integrated into one processing unit, or each unit may exist as a separate physical unit, or two or more units may be integrated into one unit.

The above embodiments can be achieved wholly or partially by software, hardware, firmware, or any combination thereof. When implemented in software, the embodiments may be implemented wholly or partially as a computer program product. The computer program product comprises one or more computer instructions. When the computer program instructions are loaded and executed on a computer, all or part of the processes or functions described in the embodiments of the present disclosure are performed. The computer may be a general-purpose computer, a special-purpose computer, a computer network, or other programmable devices. The computer instructions can be stored in a computer-readable storage medium, or transmitted from one computer-readable storage medium to another. For example, the computer instructions may be transmitted from one website, computer, server, or data center to another website, computer, server, or data center via wired means (e.g., coaxial cable, optical fiber, digital subscriber line (DSL)) or wireless means (e.g., infrared, radio, microwave). The computer-readable storage medium may be any available medium that can be read by a computer, or data storage devices such as servers or data centers that include one or more integrated available media. The available medium may include magnetic media (e.g., floppy disks, hard disks, magnetic tapes), optical media (e.g., digital versatile discs (DVD)), semiconductor media (e.g., solid state disks (SSD)) or the like.

The above description is only specific embodiments of the present disclosure. However, the scope of the present disclosure is not limited thereto. Any modifications or substitutions readily apparent to those skilled in the art within the technical scope disclosed herein should be covered by the protection scope of the present disclosure. Therefore, the protection scope of the present disclosure should be defined by the claims.

What is claimed is:

1. A method for wireless communications, comprising:
determining, by a terminal device based on relative motion information between a network device and the terminal device, a collision ambiguity period for uplink transmission, wherein the collision ambiguity period is configured as a period of cancelling the uplink transmission.

2. The method according to claim 1, wherein the relative motion information comprises one or more of the following:
position information of the terminal device;
position information of the network device;
a moving velocity of the terminal device; or
a moving velocity of the network device.

3. The method according to claim 1, wherein the determining, by the terminal device based on the relative motion information between the network device and the terminal device, the collision ambiguity period for the uplink transmission comprises:
determining, by the terminal device based on the relative motion information, a correction value of a collision location, wherein the collision location is a position at which the uplink transmission and downlink reception collide as determined based on a timing advance (TA) report; and
determining the collision ambiguity period based on the correction value of the collision location.

4. The method according to claim 3, wherein the correction value of the collision location is a ratio of a change in a distance between the network device and the terminal device over a predetermined duration to a signal transmission speed.

5. The method according to claim 4, wherein the correction value of the collision location is
$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert ,$$
ΔTA represents the correction value of TA, \vec{L_{GNB}} represents a position of the network device in a coordinate system, and \vec{L_{UE}} represents a position of the terminal device in the coordinate system, the coordinate system is a Cartesian coordinate system established with the position of the terminal device as a reference point, \vec{V} represents a moving velocity of the network device, T represents the predetermined duration, and c represents the speed of light.

6. The method according to claim 4, wherein the predetermined duration is equal to a periodicity for reporting the TA report by the terminal device.

7. The method according to claim 3, wherein
the collision ambiguity period is [TA0−ΔTA, TA0] in a case where the network device and the terminal device are moving toward each other; and
the collision ambiguity period is [TA0, TA0+ΔTA] in a case where the network device and the terminal device are moving away from each other, wherein TA0 represents the collision location, and ΔTA represents the correction value of the collision location.

8. The method according to claim 7, wherein
the network device and the terminal device are determined as moving toward each other in a case where a first angle being less than 90°; and
the network device and the terminal device are determined as moving away from each other in a case where the first angle is greater than 90°, wherein the first angle is an angle between a moving direction of the network device and a line connecting the network device and the terminal device.

9. The method according to claim 3, wherein the determining the collision ambiguity period based on the correction value of the collision location comprises:
determining the collision ambiguity period based on the collision location obtained before correction in a case that the correction value of the collision location is smaller than a threshold; or
determining the collision ambiguity period based on the collision location obtained before correction and the correction value of the collision location in a case that the correction value of the collision location is greater than or equal to the threshold.

10. The method according to claim 1, wherein a priority of downlink reception is higher than a priority of the uplink transmission.

11. The method according to claim 10, further comprising:
receiving, by the terminal device, configuration information sent by the network device, wherein the configuration information comprises priority information of the uplink transmission and the downlink reception and/or ephemeris information of the network device, and the ephemeris information comprises a position and/or a moving velocity of the network device.

12. The method according to claim 1, further comprising:
transmitting, by the terminal device, position information of the terminal device to the network device, the position information being used by the network device to determine a collision ambiguity period for downlink reception, wherein the collision ambiguity period is configured as a period of cancelling the downlink reception.

13. The method according to claim 12, wherein the transmitting, by the terminal device, the position information of the terminal device to the network device comprises:
transmitting, by the terminal device, the position information of the terminal device to the network device, in response to a change in the position of the terminal device within a predetermined time interval.

14. The method according to claim 1, wherein the terminal device is a lightweight terminal device operating in a half-duplex frequency-division duplex mode; and/or the network device is a network device disposed on a non-terrestrial platform in a non-terrestrial network (NTN).

15. A method for wireless communication, comprising:
determining, by a network device based on relative motion information between the network device and a terminal device, a collision ambiguity period for downlink reception, wherein the collision ambiguity period is configured as a period of cancelling the downlink reception.

16. The method according to claim 15, wherein the relative motion information comprises one or more of the following:
position information of the terminal device;
position information of the network device;
a moving velocity of the terminal device; or
a moving velocity of the network device.

17. The method according to claim 15, wherein the determining, by the network device based on the relative motion information between the network device and the terminal device, the collision ambiguity period for the downlink reception comprises:
determining, by the network device based on the relative motion information, a correction value of a collision location, wherein the collision location is a position at which the downlink reception and uplink transmission collide as determined based on a timing advance (TA) report; and
determining the collision ambiguity period based on the correction value of the collision location.

18. The method according to claim 17, wherein the correction value of the collision location is a ratio of a change in a distance between the network device and the terminal device over a predetermined duration to a signal transmission speed.

19. The method according to claim 18, wherein the correction value of the collision location is
$$Δ TA = \vert \frac{\vert \vec{{L}_{G N B}} - \vec{{L}_{U E}} \vert - \vert \vec{{L}_{G N B}} + \vec{V} T - \vec{{L}_{U E}} \vert}{c} \vert ,$$
ΔTA represents the correction value of TA, \vec{L_{GNB}} represents a position of the network device in a coordinate system, and \vec{L_{UE}} represents a position of the terminal device in the coordinate system, the coordinate system is a Cartesian coordinate system established with the position of the terminal device as a reference point, \vec{V} represents a moving velocity of the network device, T represents the predetermined duration, and c represents the speed of light.

20. The method according to claim 18, wherein the predetermined duration is equal to a periodicity for reporting the TA report by the terminal device.
